(19) United States
(12) Patent Application Publication
(10) Pub. No.: US 2018/0144297 A1
(43) Pub. Date: May 24, 2018

(54) A CYLINDER TRACKING SYSTEM AND METHOD

(71) Applicant: AYGAZ ANONIM SIRKETI, Istanbul (TR)

(72) Inventors: Kerem KADAYIFCIOGLU, Istanbul (TR); Emrah ISBILEN, Istanbul (TR); Emrah BIRSEN, Kocaeli (TR)

(73) Assignee: AYGAZ ANONIM SIRKETI, Istanbul (TR)

(21) Appl. No.: 15/570,257

(22) PCT Filed: Apr. 29, 2016
(86) PCT No.: PCT/TR2016/000063

§ 371 Date: Oct. 27, 2017

(30) Foreign Application Priority Data
Apr. 30, 2015 (TR) 2015/05280
Apr. 29, 2016 (TR) 2016/05570

(51) Int. Cl. G06Q 10/08

(52) U.S. Cl. CPC G06Q 10/0833

(57) ABSTRACT

A cylinder tracking system and method for tracking movements of the cylinders (T) between a filling facility, a sales dealer and a user. The system includes an identifier (5) provided inside the collar (4) of the cylinder (T) and having thereon a visual code (6); a reader system (10) situated in the re-filling facility, and including a reader unit (11) which reads the visual code (6) before and/or after the filling of the cylinder (T) and which resolves the visual code (6) to form identification information of the cylinder (T); a portable reader (12) which reads the visual code (6) on the cylinder (T) and which resolves the read visual code (6) to form identification information of the cylinder (T); and a server to which the identification information of the cylinder (T) obtained by the reader system (10) and the portable reader (12) is transmitted.

### RELEVANT FIELD OF ART

The present invention relates to a tracking system and method for tracking cylinders wherein fuels in the form of fluid are stored.

### BACKGROUND ART

Gaseous fuels such as natural gas, propane, butane and the like are liquefied under high pressure and stored in cylinders so as to be delivered to the users. The purchased cylinders are used by the users by connecting them to ovens, heating boilers, water heaters and similar devices. When the fuel in the cylinder is consumed, the users change the empty cylinder with a filled one through the sales dealers. And the empty cylinders are also returned to the filling facilities by the dealers so as to be refilled and then delivered to the users after they have been filled.

Filling such refillable cylinders, returning them back from the filling facilities to the sales dealers, selling of the same to the users and tracking the delivery of the empty cylinders received from the users to the filling facilities is of utmost importance for security. If a cylinder is not tracked, the distributor may be subjected to penal sanctions in accordance with the legislation, and serious problems may be encountered in terms of security, including the re-filling of the cylinder by unauthorized parties and selling of the same to the users. Furthermore, in such unauthorized filling, different additives may be introduced into the cylinder and thus the quality of the fuel may be reduced. This not only poses a danger for safety of the users but also decreases the brand value of the original cylinder.

In the state-of-art, as disclosed in US2012187197A1, RFID (Radio Frequency Identification) elements may be used to track the cylinders. However, said RFID elements are expensive and also said elements may easily get damaged since they are influenced by the magnetic field. Given the number of the filling of cylinders, RFID elements are not preferred for tracking cylinders.

### BRIEF DESCRIPTION OF THE INVENTION

With the present invention, there is provided a cylinder tracking system and method for tracking movements of the cylinders between a filling facility, a sales dealer and a user. Said tracking system comprises at least one cylinder having at least one body, at least one valve which is positioned on the body and supplies the fuel in the form of fluid from or into the body, at least one handle positioned on the body, at least one collar connecting the said handle to the body, at least one identifier provided inside the said collar and having thereon at least one visual code containing identification information specific to the cylinder to which it is connected; at least one reader system situated in a re-filling facility where a cylinder is filled with fuel, and including at least one reader unit which reads the said visual code before and/or after the filling of the cylinder and which resolves the read visual code to form identification information of the relevant cylinder; at least one portable reader which reads the visual code on the cylinder (for example, during the dispatch of the filled cylinder to the sales dealer and the delivery of same to the users and/or during the collection of the empty cylinder from the users and the delivery of same to the filling facility) and which resolves the read visual code to form identification information of the relevant cylinder; at least one server to which the identification information of the cylinder obtained by the reader system and the portable reader is transmitted, wherein other data associated with the cylinder identification information (i.e. serial number, date of manufacture, tare, refill date and testing dates etc.) is stored.

Said cylinder tracking method comprises the steps of reading the visual code on the identifier provided on the collar of the said cylinder by at least one reader system in the reader unit before and/or after the refilling of the cylinder in the said refilling facility, to form identification information of the said cylinder; transmitting the formed identification information to the said server along with the time information; reading of the visual code in the filled cylinder by at least one portable reader during the delivery of the cylinder to the sales dealer, to form identification information of the said cylinder; transmitting the formed identification information to the said server along with the time information and information about the sales dealer to which the cylinder will be delivered; reading of the visual code in the cylinder by at least one portable reader during the selling of the cylinder to the users, to form identification information of the said cylinder; transmitting the formed identification information to the said server along with the time information and information about the user to which the cylinder is sold; reading of the visual code on the empty cylinder obtained from the user by at least one portable reader in order to form identification information of the empty cylinder; transmitting the formed identification information to the said server along with the time information.

### OBJECT OF THE INVENTION

An object of the present invention is to provide:
a cylinder tracking system and method for tracking cylinders wherein fuels in the form of fluid are stored,
a cylinder tracking system and method for tracking cylinders in a reliable and fast manner,
a cylinder tracking system and method wherein the identifier element provided on the cylinders therein is durable and long-lasting.

### DESCRIPTION OF THE DRAWINGS

The illustrative embodiments of a cylinder tracking system according to the present invention are illustrated in the enclosed drawings, in which:

FIG. 1 is a perspective view of a cylinder used in the cylinder tracking system according to the present invention.

FIG. 2 is a detailed view of an identifier used in the cylinder tracking system according to the present invention.

FIG. 3 is a perspective view of a reader system used in the cylinder tracking system according to the present invention.

FIG. 4 is a perspective view of a portable reader used in the cylinder tracking system according to the present invention.

All the parts illustrated in the drawings are individually assigned a reference numeral and the corresponding terms of these numbers are listed as follows:
Cylinder (T)
Body (1)
Valve (2)
Handle (3)
Collar (4)
Identifier (5)
Visual code (6)
Serial number (7)
Brand (8)
Hole (9)
Reader system (10)
Reader unit (11)
Portable reader (12)

### DESCRIPTION OF THE INVENTION

Fuels in the form of fluid (e.g. liquefied gaseous fuels such as LPG) are stored in cylinders so as to be delivered to the users. The cylinders wherein gaseous fuels are stored may have various shapes and sizes based on the area of usage and intended purpose (for example, 2 kg camping cylinder, 12 kg domestic cylinder, 24 or 45 kg industrial cylinder etc.). After the fuel inside the said cylinders is consumed, the cylinders are returned to the filling facilities so as to be re-filled. Tracking of the cylinders during their movements between the filling facility, the sales dealer and the user is of utmost importance for security. Therefore, with the present invention, there is provided a cylinder tracking system and method for tracking cylinders.

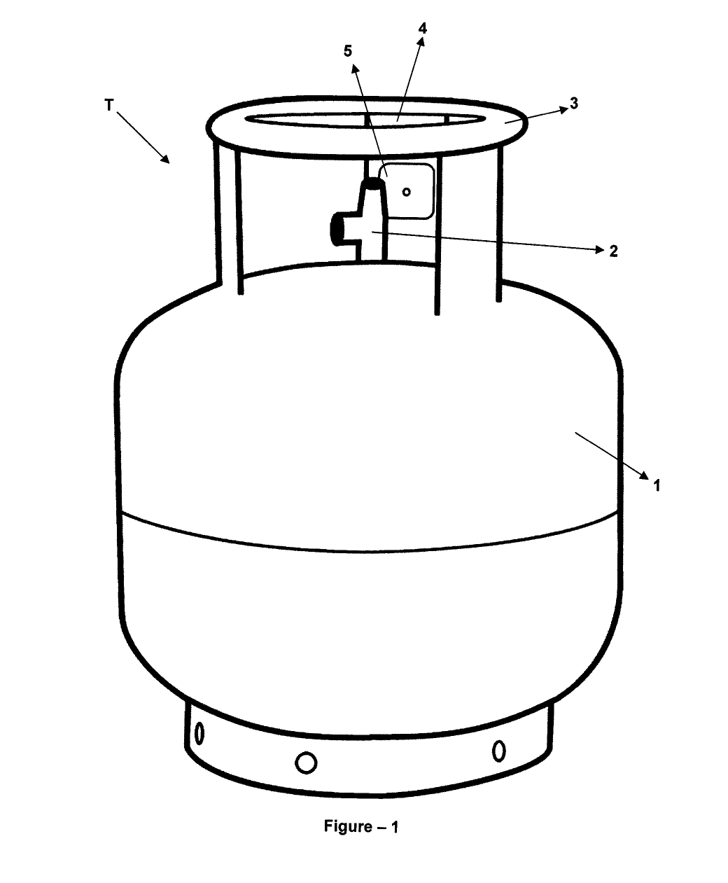

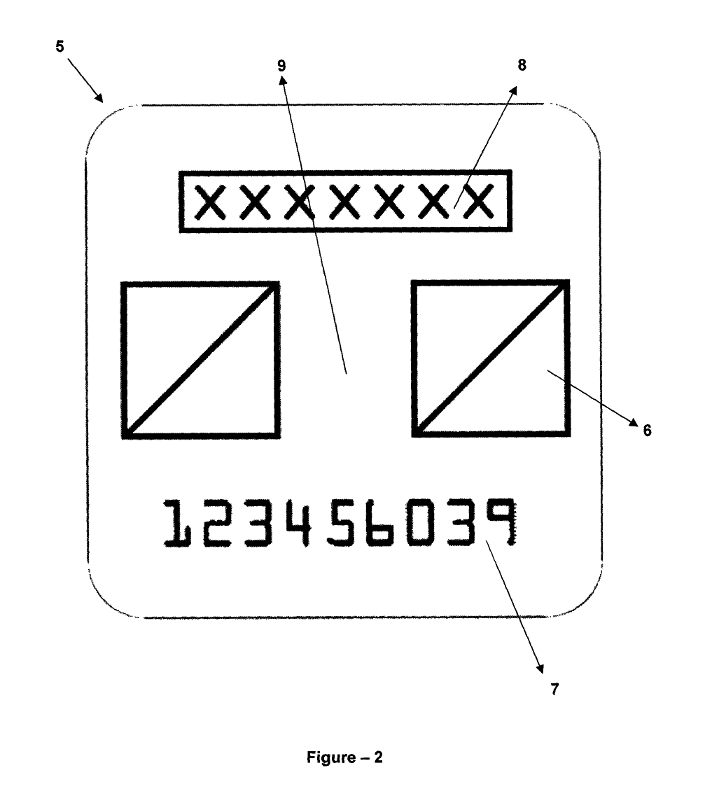

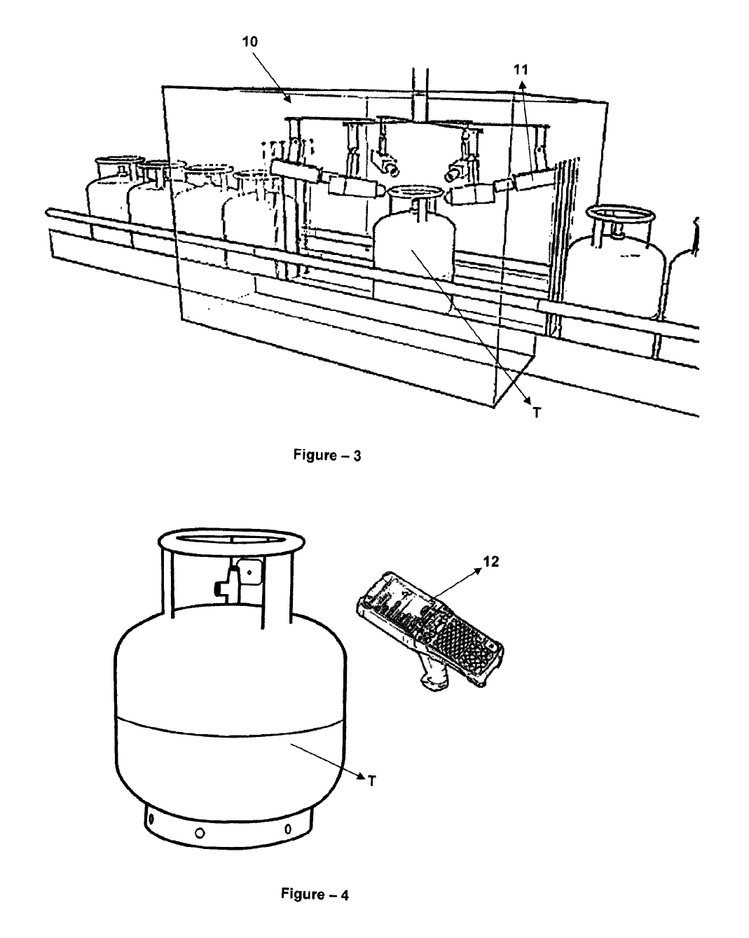

The cylinder tracking system according to the present invention, as illustrated in FIGS. 1-4, comprises at least one cylinder (T) having at least one body (1), at least one valve (2) that is positioned on the body (1) and supplies the fuel in the form of fluid from or into the body (1), at least one handle (3) positioned on the body (1) (for example, preferably on the periphery of the said valve (2)), at least one collar (4) connecting the said handle (3) to the body (1), at least one identifier (5) provided inside the said collar (4) (i.e. on that part facing the mouth (2)) and having thereon at least one visual code (6) containing identification information specific to the cylinder (T) to which it is connected; at least one reader system (10) situated in a filling facility where the cylinder (T) is filled with fuel, and including at least one reader unit (11) which reads the said visual code (6) before and/or after the filling of the cylinder (T) and which resolves the read visual code (6) to form identification information of the relevant cylinder (T); at least one portable reader (12) which reads the visual code (6) on the cylinder (T) (for example, during the dispatch of the filled cylinder (T) to the sales dealer and the delivery of same to the users and/or during the collection of the empty cylinder (T) from the users and the delivery of same to the filling facility) and which resolves the read visual code (6) to form identification information of the relevant cylinder (T); at least one server to which the identification information of the cylinder (T) obtained by the reader system (10) and the portable reader (12) is transmitted, wherein the cylinder (T) identification information as well as other data associated with the said identification information (i.e. serial number, date of manufacture, tare, refill date and testing dates etc.) is stored.

In an illustrative embodiment of the cylinder tracking system according to the present invention, the visual code (6) on the cylinder (T) to be filled with fuel in the filling facility is read by the said reader system (10) to achieve identification information of the cylinder (T). The obtained identification information is transmitted to the server. In the said server, the data about the relevant cylinder (T) is updated together with the time information and process information (e.g. which process is applied to the cylinder (T)) (for example, the date on which the empty cylinder is read is recorded on the server). After the cylinder (T) has been filled, identification information obtained by reading the visual code (6) on the cylinder (T) by the reader system (10) is transmitted to the server. The data about the relevant cylinder (T) is again updated along with the time information (e.g. the filling date of the cylinder is recorded on the server). Thus, information about the time when a cylinder (T) is filled is recorded. The visual code (6) on the cylinder (T) is read by the portable reader (12) while the cylinders (T) that have been filled are being delivered to the sales dealers, and the obtained identification information (along with the sales information) is transmitted to the server. Thus, it is also recorded when and to which sales dealer a cylinder (T) is delivered. By reading of the visual code (6) by the portable reader (12) during the selling of the cylinder (T) to the users (during the exchange of an empty cylinder at the hand of the user with a filled one brought by the sales dealer), it is also recorded which cylinder is sold to whom. Here, reading of the visual code (6) on the empty cylinder (T) obtained from the user also allows to record the cylinders (T) to be returned to the filling facility. In the cylinder tracking system according to the present invention, since the visual code (6) on the cylinder (T) is read in all steps of the selling and refilling of the cylinder (T) and the relevant information is transmitted to the server, it may be prevented that the cylinder (T) is filled and sold in an illegal manner. Thus, sales of low quality and hazardous fuel to the users may be prevented.

The cylinder tracking method employing the cylinder tracking system according to the present invention, and designed for tracking at least one cylinder (T) during its movements between a filling facility, a sales dealer and a user, comprises the steps of reading the visual code (6) on the identifier (5) provided on the collar (4) of the said cylinder (T) by at least one reader system (10) in the reader unit (10) before and/or after the filling of the cylinder (T) in the said filling facility, to form identification information of the said cylinder (T); transmitting the formed identification information to the said server along with the time information (the date and time on which the visual code (6) is read); reading of the visual code (6) in the filled cylinder (T) by at least one portable reader (12) during the delivery of the cylinder (T) to the sales dealer, to form identification information of the said cylinder (T); transmitting the formed identification information to the said server along with the time information (the time on which the visual code (6) is read) and information about the sales dealer to which the cylinder will be delivered; reading of the visual code (6) in the cylinder (T) by at least one portable reader (12) during the selling of the cylinder (T) to the users, to form identification information of the said cylinder (T); transmitting the formed identification information to the said server along with the time information (the time on which the visual code (6) is read) and information about the user to whom the cylinder is sold; reading of the visual code on the empty cylinder (T) obtained from the user by at least one portable reader (12) in order to form identification information of the empty cylinder (T); transmitting the formed identification information to the said server along with the time information (the time on which the visual code (6) is read).

In an illustrative embodiment of the invention, said reader unit (11) includes at least one camera and at least one control unit. In this embodiment, the visual code (6) captured by the camera is analyzed by the control unit so as to obtain identification information of the cylinder (T). In illustrative embodiments of the invention, the said visual code (6) is in the form of a barcode or a two-dimensional code. Based on the form of the visual code (6), said control unit generates numerical data or alphanumerical data (if the visual code (6) is in the form of a barcode, numerical data is obtained, if the visual code (6) is in the form of a two-dimensional code, alphanumerical data is obtained). Since the said visual code (6) varies according to each cylinder (T), data (identification information) obtained by analyzing the visual code (6) by the control unit is also varied for each cylinder (T). In this way, all cylinders (T) of a firm may be tracked individually.

In an alternative embodiment of the invention, said reader system (10) comprises at least two (preferably six) reader units (11). In this embodiment, due to the use of a plurality of reader units (11), even if it is not read by a reader unit (11), the identifier (5) provided inside the collar (4) is read by at least another reader unit (11).

In another alternative embodiment of the invention, said reader system (10) includes at least one driving system (not shown) that drives the reader unit (11) about an axis (i.e., a vertical axis passing through the valve (2) of the cylinder). In this embodiment, said driving system drives the reader unit (11) such that it takes a position to read the identifier (5) provided inside the collar (4). In this way, the identifier (5) is properly read by the reader unit (11).

In another preferred embodiment of the invention, said identifier (5) is in the form of a plate (i.e. a sheet) connected to the collar (4). In this embodiment, the identifier (5) comprises at least one hole (9) for connection with the collar (4). Said hole (9) is preferably located at the center of the identifier (5). In this embodiment, the identifier (5) in the form of a plate is preferably connected to the collar (4) by means of a rivet. In this way, the identifier (5) is connected to the collar (4) in a practical and reliable manner.

In another preferred embodiment of the invention, said identifier (5) includes at least two visual codes (6). In this embodiment, in the event that one of the visual codes (6) is damaged or not read properly, the other visual code (6) may be read.

In another preferred embodiment of the invention, said identifier (5) includes at least one serial number (7). In another preferred embodiment, the identifier (5) includes at least one brand (8) information.

In another preferred embodiment of the invention, said reader system (10) preferably comprises at least one reader unit (11), in the form of a camera, which captures the images (takes photos) of the collar (4) provided on the cylinder (T) (which may be a collar with or without an identifier (5)) and of the identifier (5), at least one scanner which analyses the visual code (6) in an image (an image with an identifier (5)) captured by the reader unit (11) to obtain identification information of the cylinder (T), and at least one transmission member that transmits the identification information obtained through the captured image to the server. In this embodiment, when the photos of the collars with and without an identifier (5) are taken, and the photo of the collar with an identifier (5) as well as the identification information obtained from the visual code (6) of the identifier (5) is transmitted to the server, such information as the serial number (7), date of manufacture, and testing date that are gathered from all photos is matched with the identification information of the cylinder (T) (if different information is present on the identifier (5), said different information is also matched with the identification information of the cylinder (T)). Thus, the information about the cylinder (T) is matched in the server in a fast and a practical manner. Furthermore, if any information in the identifier (5) is damaged, for example, the damaged information may be recovered by means of other information in the identifier (5). For example, when the visual code (6) is damaged, the serial number (7) in the identifier (5) is used to achieve the visual code (6) information matching with the serial number in the server.

In an illustrative embodiment of the invention, said portable reader (12) is in the form of a customized device for reading the said visual code (6). In an alternative embodiment, the portable reader (12) is a portable smart device (i.e. a mobile phone or a tablet) with special software for reading the visual code (6).

In the cylinder tracking system according to the present invention, since the identifier (5) on the cylinder (T) is positioned inside the collar (4), the visual code (6) on the identifier is prevented from being damaged and thus the identifier (5) is made long-lasting. Furthermore, since the reader system (10) in the filling facility comprises at least two reader units (11), the identifier (5) positioned inside the collar (4) is read in an easy manner.

1-17. (canceled)

18. A cylinder tracking system for tracking at least one cylinder (T), wherein a fuel in the form of fluid is stored, during its movements between a filling facility, a sales dealer and user, and having at least one body (1), at least one valve (2) that is positioned on the body (1) and supplies the fuel in the form of fluid from or into the body (1), at least one handle (3) positioned on the body (1), at least one collar (4) connecting the said handle (3) to the body (1), comprising
at least one identifier (5) provided inside the said collar (4) and having thereon a visual code (6) containing identification information specific to the cylinder (T) to which it is connected;
at least one reader system (10) situated in the said re-filling facility, and including a reader unit (11) which reads the said visual code (6) before and/or after the filling of the cylinder (T) and which resolves the read visual code (6) to form identification information of the relevant cylinder (T);
at least one portable reader (12) which reads the visual code (6) on the cylinder (T) and which resolves the read visual code (6) to form identification information of the relevant cylinder (T);
at least one server to which the identification information of the cylinder (T) obtained by the reader system (10) and the portable reader (12) is transmitted, wherein the cylinder (T) identification information as well as other data associated with the said identification information is stored; characterized in that the identifier comprises at least two visual codes (6) in the form of barcode and/or two dimensional code and the reader system (10) comprises at least two reader units (11) and said reader system (10) includes at least one driving system that drives the reader unit (11) about an axis.

19. A cylinder tracking system according to claim 1, characterized in that said reader unit (11) includes at least one camera and at least one control unit wherein the visual code (6) captured by the camera is analyzed so as to obtain identification information of the cylinder (T).

20. A cylinder tracking system according to claim 1, characterized in that said reader system (10) includes six reader units (11).

21. A cylinder tracking system according to claim 1, characterized in that said identifier (5) is in the form of a plate connected to the collar (4).

22. A cylinder tracking system according to claim 4, characterized in that said identifier (5) includes at least one hole (9).

23. A cylinder tracking system according to claim 1, characterized in that the identifier (5) includes at least one serial number (7).

24. A cylinder tracking system according to claim 1, characterized in that the identifier (5) includes at least one brand (8) information.

25. A cylinder tracking system according to claim 1, characterized in that said portable reader (12) is in the form of a customized device for reading the said visual code (6).

26. A cylinder tracking system according to claim 1, characterized in that said portable reader (12) is a portable smart device with special software for reading the visual code (6).

27. A cylinder tracking system according to claim 1, characterized in that said reader system (10) comprises at least one reader unit (11) which captures the images of the collar (4) provided on the cylinder (T) and of the identifier (5); at least one scanner which analyses the visual code (6) in an image captured by the reader unit (11) to obtain identification information of the cylinder (T); and at least one transmission member that transmits the identification information obtained through the captured image to the said server.

28. A cylinder tracking method employing a cylinder tracking system according to any one of the preceding claims, and designed for tracking at least one cylinder (T) during its movements between a filling facility, a sales dealer and a user, characterized by comprising the steps of:
reading the visual code (6) on the identifier (5) provided on the collar (4) of the said cylinder (T) by at least one reader system (10) in the reader unit (10) before and/or after the refilling of the cylinder (T) in the said filling facility, to form identification information of the said cylinder (T);
transmitting the formed identification information to the said server along with the time information;
reading of the visual code (6) in the filled cylinder (T) by at least one portable reader (12) during the delivery of the cylinder (T) to the sales dealer, to form identification information of the said cylinder (T);
transmitting the formed identification information to the said server along with the time information and information about the sales dealer to which the cylinder will be delivered;
reading of the visual code (6) in the cylinder (T) by at least one portable reader (12) during the selling of the cylinder (T) to the users, to form identification information of the said cylinder (T);
transmitting the formed identification information to the said server along with the time information and information about the user to which the cylinder is sold;
reading of the visual code on the empty cylinder (T) obtained from the user by at least one portable reader (12) in order to form identification information of the empty cylinder (T);
transmitting the formed identification information to the said server along with the time information.

29. A method according to claim 11, characterized by comprising the step of capturing the images of the collar (4) provided on the cylinder (T) and of the identifier (5) during the step of obtaining identification information of the cylinder (T).

30. A method according to claim 12, characterized in that the captured images are also transmitted to the server during the step of transmitting the formed identification information to the said server along with the time information.
